(19) United States
(12) Patent Application Publication
(10) Pub. No.: US 2010/0037740 A1
(43) Pub. Date: Feb. 18, 2010

(54) Dust Control Hood Assembly for a Cutting Machine

(76) Inventor: Kun-Yen Lin, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/193,093

(22) Filed: Aug. 18, 2008

(51) Int. Cl. B27G 19/02; B27B 5/29; B26D 7/18

(52) U.S. Cl. 83/100; 83/860; 83/478; 144/252.1

(57) ABSTRACT

A dust control hood assembly for use with a cutting machine including a hood and a lifting device. The hood includes a front end having a first set of wheels, a rear end having a second set of wheels and a handle attached to the front end thereof. The lifting device includes a fixed arm having a connecting end for fixing with a dust collector and a suspended end, and a set of pivotal arms each having a first end installed to the suspended end of the fixed arm and a second end installed to the hood. A workpiece is adapted to impose a momentum to the hood so that the hood is adapted to be lifted upward by the workpiece, and the hood is adapted to be pivoted with respect to the fixed arm.

### BACKGROUND OF THE INVENTION

1. Field of the Invention

The present invention relates to the field of a cutting machine, in particular, to a dust control hood assembly for use with a cutting machine.

2. Description of the Related Art

Referring to U.S. Pat. No. 4,875,398 to Taylor, a retractable dust control hood and guard for a rotary table saw includes a hood and a support mechanism having a parallelogram linkage and a counterbalance mechanism for supporting the hood for movement between a working position and a retracted position, and the counterbalance mechanism utilizes a biasing device to counteract the weight of the hood in order to facilitate an operator to move the hood between the working position and the retracted position. Unfortunately, since the biasing device of the counterbalance mechanism is susceptible to suffer a mechanical fatigue due to repeated extension and compression imposed thereto, a frequent adjustment to the counterbalance mechanism is required.

The present invention is, therefore, intended to obviate or at least alleviate the problems encountered in the prior art.

### SUMMARY OF THE INVENTION

According to the present invention there is provided, a dust control hood assembly for use with a cutting machine having a support surface for supporting a workpiece during a cutting operation, and a cutting blade projecting above the support surface, as well as a dust collector for collecting the dust generated by the workpiece, including a hood encapsulating the cutting blade and defining a cavity and an open bottom for containing and evacuating dust generated by the workpiece, the hood further including a front end having a first set of wheels and a rear end having a second set of wheels, with the first and second sets of wheels being supported by the support surface and keeping the hood slightly spaced from the support surface, and a handle attached to the front end thereof, with the handle including a first end in proximity to the first set of wheels and a second end extending from the first end and angled with respect to the first end and defining a guiding portion against which the workpiece moves to start pivotal movement of the hood. A lifting device includes a fixed arm having a connecting end for fixing with the dust collector and a suspended end, and a set of pivotal arms each having a first end installed to the suspended end of the fixed arm and a second end installed to the hood to enable the hood pivot with respect to the fixed arm.

In one aspect of the present invention, the workpiece imposes a momentum to the hood so that the hood is adapted to be lifted upward by the workpiece, and the hood is adapted to be pivoted with respect to the fixed arm.

In another aspect of the present invention, each of the set of pivotal arms is angled with respect to the fixed arm, with the fixed arm and each of the set of pivotal arms cooperate to define an acute angle. As a result, when the workpiece urges the hood, the hood can be easily lifted up.

In yet another aspect of the present invention, the suspended end of the fixed arm is substantially parallel to the support surface. As a result, when the workpiece urges the hood, the hood can be easily lifted up.

In a further aspect of the present invention, the first and second sets of wheels are adapted to make the hood move relative to the support surface of the cutting machine without abrading the support surface.

In a further aspect of the present invention, the first and second sets of wheels are adapted to enable the hood to easily move relative on the workpiece.

In a further aspect of the present invention, the guiding portion of the handle facilitates initial pivotal movement of the hood and an access of the workpiece.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The present invention will be described with reference to the accompanying drawings which assist in illustrating the pertinent features thereof, in which:

FIG. 1 is a perspective view of a dust control hood assembly in accordance with the present invention.

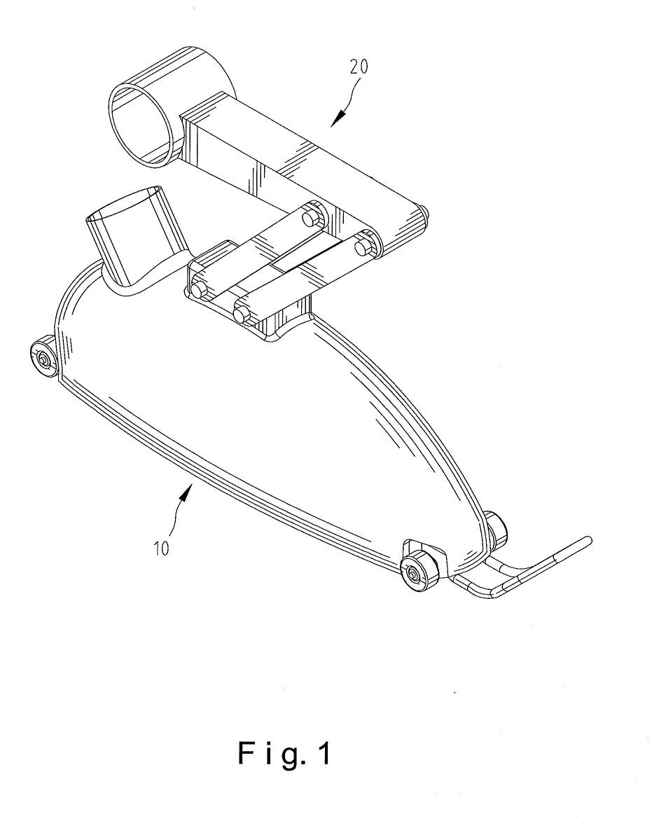

FIG. 2 is an exploded perspective view of FIG. 1.

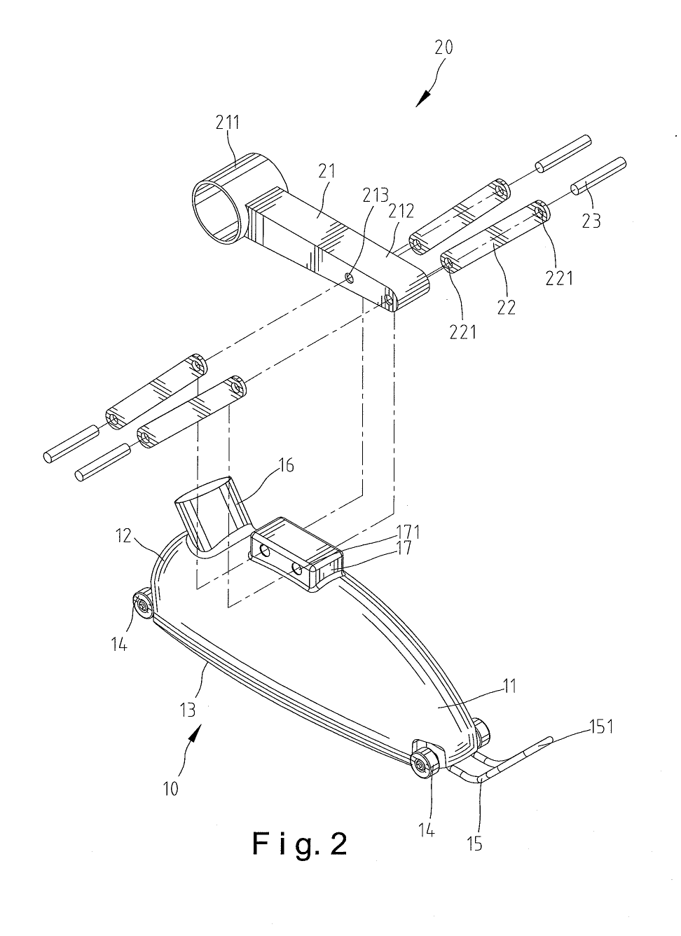

FIG. 3 is a perspective view illustrating a cutting machine installed with the dust control hood assembly of the present invention.

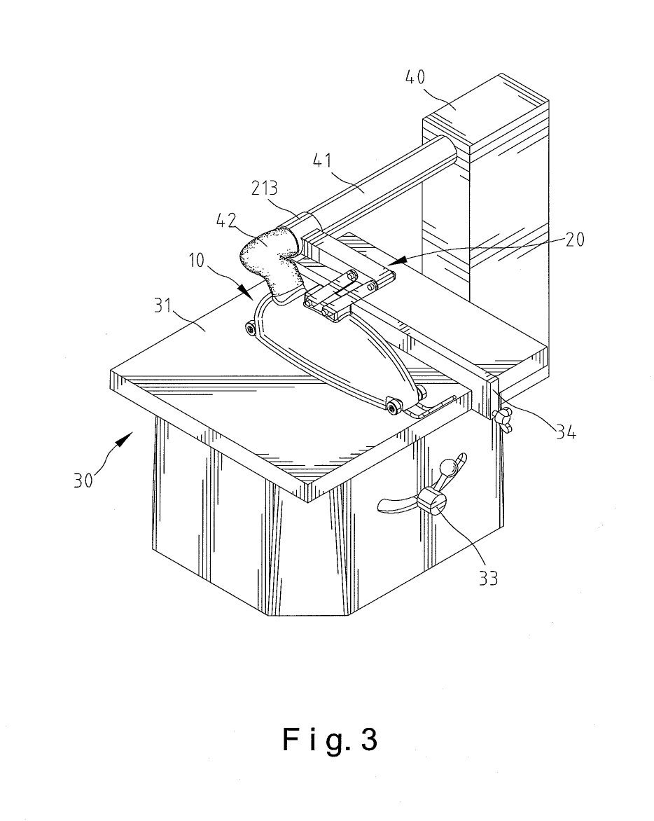

FIG. 4 is a side, cross-sectional view of FIG. 3.

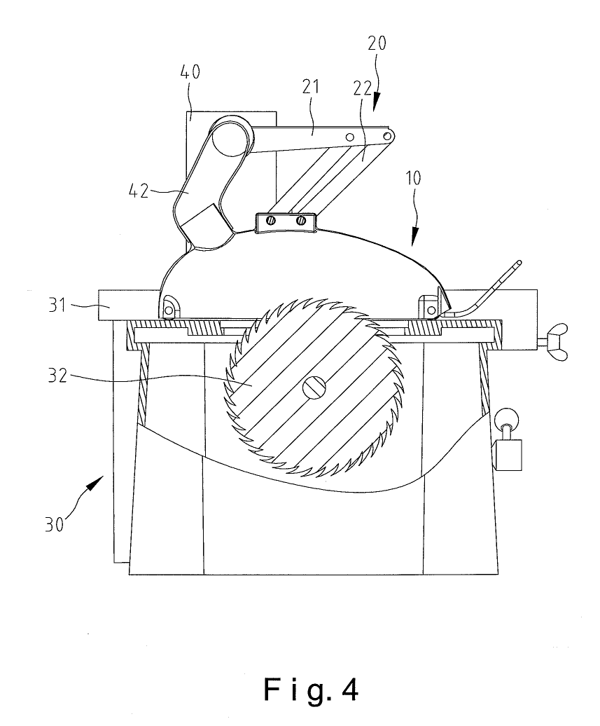

FIG. 5 is a side view illustrating a workpiece to be cut by the cutting machine, with the dust control hood assembly having a hood adapted to be lifted upward by the workpiece.

FIG. 6 is another side view illustrating the workpiece is further fed into the cutting machine, and the hood is further lift upward by the workpiece.

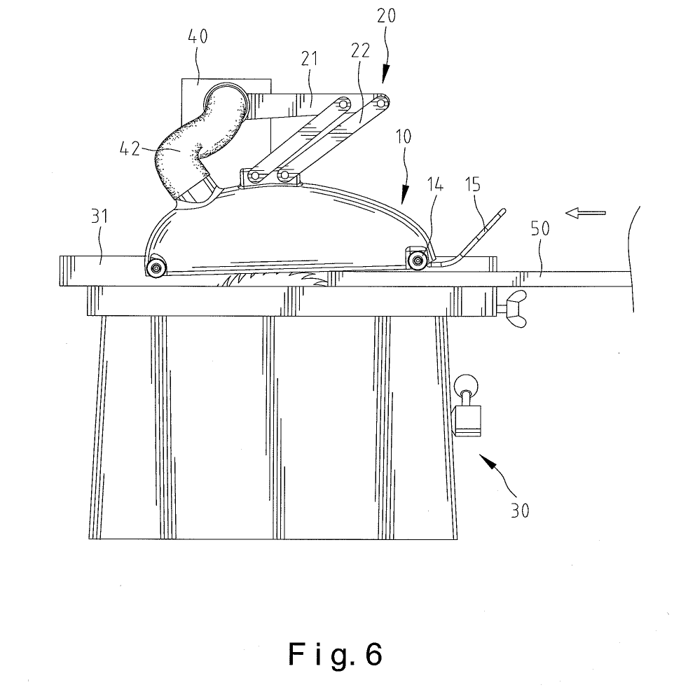

### DETAILED DESCRIPTION OF THE PREFERRED EMBODIMENT

Referring to the drawings, a dust control hood assembly in accordance with the present invention is adapted to be installed to a cutting machine 30. Particularly, the cutting machine 30 includes a support surface 31 for supporting a workpiece 50 during a cutting operation, a cutting blade 32 projecting above the support surface 31, a control device 33 for making the cutting blade 32 go upward or downward, and a fence assembly 34.

The dust control hood assembly includes a hood 10 having a cavity and an open bottom 13, adapted to encapsulate the cutting blade 32 and the workpiece 50 so that when the workpiece 50 is being cut, the hood 10 is adapted to contain the dust within the hood 10. The hood may be made of pellucid material to allow the operator to aware of the cutting process. In addition, the duct control hood assembly may utilize a dust collector 40 to evacuate the dust collected in the hood 10. In this preferred embodiment, the hood 10 includes a tube 16 extended therefrom for connection with the dust collector 40, and with the tube 16 defining a space in communication with the cavity of the hood 10. Typically, the dust collector 40 includes a first pipe 41 extended therefrom and a second pipe 42 having one end joined with the first pipe 41 and anther end adapted to connect to the tube 16, and the second pipe 42 is bendable.

The hood 10 also includes a front end 11 having a first set of wheels 14 and a rear end 12 having a second set of wheels 14, with the first and second sets of wheels 14 being supported by the support surface 31 and keeping the hood 10 slightly spaced from the support surface, and a handle 15 attached to the front end thereof. The handle 15 includes a first end in proximity to the first set of wheels 14 and a second end extending from the first end and angled with respect to the first end, and with the second end defining a guiding portion 151.

The dust control hood assembly further includes a lifting device 20 which includes a fixed arm 21 above the hood 11 and having a connecting end 211 for fixing with the first pipe 41 of the dust collector 40 and a suspended end 212 substantially parallel to the support surface 31, and a set of pivotal arms 22 each having a first end installed to the suspended end 212 of the fixed arm 21 and a second end installed to a joint 17 mounted on the hood 10. To securely fix the first end of each pivotal arms 23 to the suspended end 212, each pivotal arm 22 may include a through holes 221 defined at the first end thereof, and the suspended end 212 may include a corresponding hole 213 for insertion of a fastener 23. Likewise, to securely fix the second end of each pivotal arms 23 to the joint 17, each pivotal arm 22 may include a through holes 221 defined at the second end thereof, and the joint 17 may include a corresponding hole 171 for insertion of another fastener 23. In addition, when each pivotal arm 22 is installed, the fixed arm 21 and each pivotal arm 22 would cooperate to define an acute angle. Also, in the preferred embodiment, the set of pivotal arms 22 are arranged in two arrays, with one of the arrays positioned opposite to another.

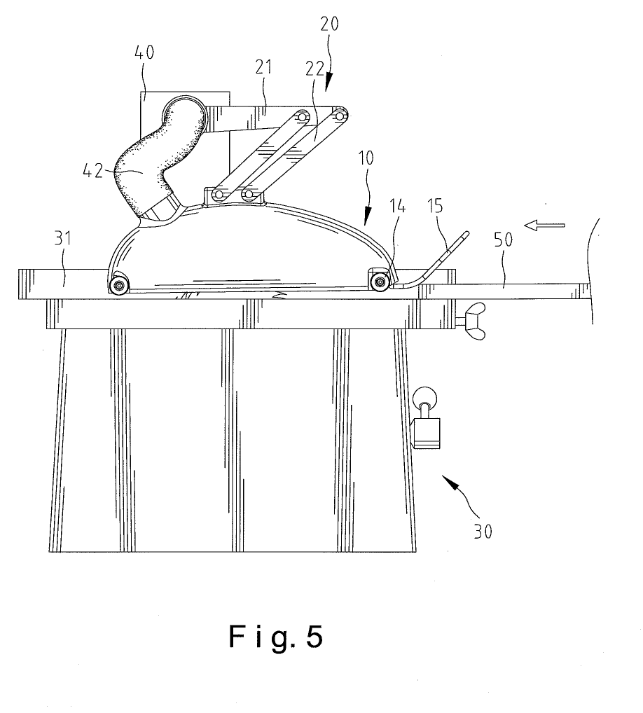

In operation of the dust control hood, the operator moves the workpiece 50 toward the hood 10 as illustrated in FIG. 5, and as movement is proceeded further, the guiding portion 151 of the handle 15 is adapted to facilitate initial pivotal movement of the hood and an assess of the workpiece 50, the hood 10 is then pivoted with respect to the fixed arm 21, and the hood 10 is adapted to be lifted upward by the workpiece 50 as well as adapted to be pivoted with respect to the fixed arm 21. Then, as the movement continues further, the fixed arm 21 and each pivotal arm 22 cooperate a gradually decreased acute angle.

Therefore, according to the forgoing, it is one aspect of the present invention that the workpiece 50 would imposes a momentum to the hood 10 so that the hood 10 is adapted to be lifted upward by the workpiece 50, and the hood 10 is adapted to be pivoted with respect to the fixed arm 21.

In yet another aspect of the present invention, the suspended end 212 of the fixed arm 21 is substantially parallel to the support surface 31. As a result, when the workpiece 50 urges the hood 10, the hood can be easily lifted up.

In a further aspect of the present invention, the first and second sets of wheels 14 are adapted to make the hood 10 move relative to the support surface 31 of the cutting machine 30 without abrading the support surface 31.

In a further aspect of the present invention, the first and second sets of wheels 14 are adapted to enable the hood 10 to easily move relative on the workpiece 50.

In a further aspect of the present invention, the guiding portion 151 of the handle 15 facilitates initial pivotal movement of the hood 10.

While the specific embodiments have been illustrated and described, numerous modifications come to mind without significantly departing from the spirit of invention and the scope of invention is only limited by the scope of accompanying claims.

What is claimed is:

1. A dust control hood assembly for use with a cutting machine, the cutting machine has a support surface for supporting a workpiece during a cutting operation, a cutting blade projecting above the support surface, and a dust collector for collecting the dust generated by the workpiece, the dust control hood assembly comprising:
a hood encapsulating the cutting blade and defining a cavity and an open bottom for containing and evacuating dust generated by the workpiece, the hood further including a front end having a first set of wheels and a rear end having a second set of wheels, with the first and second sets of wheels being supported by the support surface and keeping the hood slightly spaced from the support surface; and
a lifting device including a fixed arm having a connecting end for fixing with the dust collector and a suspended end, and a set of pivotal arms each having a first end installed to the suspended end of the fixed arm and a second end installed to the hood to enable the hood pivot with respect to the fixed arm; and
wherein the hood is adapted to be lifted upward by the workpiece, and the hood is adapted to be pivoted with respect to the fixed arm.

2. The dust control hood assembly as claimed in claim 1, with each of the set of pivotal arms angled with respect to the fixed arm, with the fixed arm and each of the set of pivotal arms cooperate to define an acute angle, and when the workpiece lifts the hood up the acute angle is gradually decreased.

3. The dust control hood assembly as claimed in claim 1, with the hood including a joint mounted on the hood, and with the joint connected to the second end of each of the set of pivot arms.

4. The dust control hood assembly as claimed in claim 1, with the hood including a tube extended therefrom for connection with the dust collector, and with the tube defining a space in communication with the cavity of the hood.

5. The dust control hood assembly as claimed in claim 1, with the hood being pellucid.

6. The dust control hood assembly as claimed in claim 1, with the hood including a handle attached to the front end thereof, with the handle including a first end in proximity to the first set of wheels and a second end extending from the first end and angled with respect to the first end, and with the second end defining a guiding portion.

7. The dust control hood assembly as claimed in claim 1, with the suspended end of the fixed arm being substantially parallel to the support surface.

8. The dust control hood assembly as claimed in claim 2, with the hood including a joint mounted on the hood, and with the joint connected to the second end of each of the set of pivot arms.

9. The dust control hood assembly as claimed in claim 2, with the hood including a tube extended therefrom for connection with the dust collector, and with the tube defining a space in communication with the cavity of the hood.

10. The dust control hood assembly as claimed in claim 2, with the hood being pellucid.

11. The dust control hood assembly as claimed in claim 2, with the hood including a handle attached to the front end thereof, with the handle including a first end in proximity to the first set of wheels and a second end extending from the first end and angled with respect to the first end, and with the second end defining a guiding portion.

12. The dust control hood assembly as claimed in claim 2, with the suspended end of the fixed arm being substantially parallel to the support surface.

13. The dust control hood assembly as claimed in claim 1, with the set of pivotal arms arranged in two arrays, with one of the arrays positioned opposite to another.

14. The dust control hood assembly as claimed in claim 1, with the first set of wheels including at least two wheels positioned opposite to one another, and with the second set of wheels including at least two wheels positioned opposite to one another.
